(19) United States
(12) Patent Application Publication
(10) Pub. No.: US 2017/0125796 A1
(43) Pub. Date: May 4, 2017

(54) POSITIVE ELECTRODE ACTIVE MATERIAL FOR NONAQUEOUS ELECTROLYTE SECONDARY BATTERIES, AND NONAQUEOUS ELECTROLYTE SECONDARY BATTERY

(71) Applicant: SANYO ELECTRIC CO., LTD., Moriguchi-shi (JP)

(72) Inventors: Yuma Kamiyama, Osaka (JP); Takeshi Ogasawara, Hyogo (JP); Hidekazu Hiratsuka, Osaka (JP)

(73) Assignee: SANYO Electric Co., Ltd., Daito-shi (JP)

(21) Appl. No.: 15/107,416

(22) PCT Filed: Oct. 14, 2014
(86) PCT No.: PCT/JP2014/005205

§ 371 Date: Jun. 22, 2016

(30) Foreign Application Priority Data
Dec. 26, 2013 (JP) 2013-268876

(51) Int. Cl. H01M 4/36; H01M 4/525; C04B 35/64; C04B 35/01; C04B 35/626; H01M 4/505; H01M 4/48

(52) U.S. Cl. CPC H01M 4/362; H01M 4/505; H01M 4/525; H01M 4/483; C04B 35/016; C04B 35/62675; C04B 35/64; H01M 2004/021

(57) ABSTRACT

This positive electrode active material for nonaqueous electrolyte secondary batteries contains: first particles which have an average surface roughness of 4% or less and are mainly configured of a lithium-nickel composite oxide wherein the ratio of Ni relative to the total number of moles of metal elements other than Li is more than 30% by mole; and second particles which are present on the surfaces of the first particles and are mainly configured of at least one hydroxide selected from among hydroxides of lanthanoid elements (excluding La and Ce) and oxyhydroxides.

### TECHNICAL FIELD

The present disclosure relates to a positive electrode active material for nonaqueous electrolyte secondary batteries and a nonaqueous electrolyte secondary battery.

### BACKGROUND ART

Patent Literature 1 discloses a positive electrode active material in which fine particles of a hydroxide of a rare earth element (hereinafter, referred to as “rare earth particles”) are attached on the surface of particles of a lithium-nickel composite oxide. Patent Literature 1 discloses that using the positive electrode active material makes it possible to suppress a reduction of discharge capacity after charge/discharge cycles.

### CITATION LIST

### Patent Literature

Patent Literature 1: International Publication No. WO 2012/099265

### SUMMARY OF THE INVENTION

### Technical Problem

However, it has been found that when the above positive electrode active material is used, the impedance increases after charge/discharge cycles.

### Solution to Problem

The positive electrode active material for nonaqueous electrolyte secondary batteries according to the present disclosure includes: first particles containing, as a main component, a lithium-nickel composite oxide wherein the percentage of Ni relative to the total number of moles of a metal element other than Li is more than 30% by mole, and having an average surface roughness of 4% or less; and second particles containing, as a main component, at least one selected from a hydroxide and an oxyhydroxide of a lanthanoid element (excluding La and Ce), and present on the surface of the first particles.

### Advantageous Effects of Invention

The positive electrode active material for nonaqueous electrolyte secondary batteries according to the present disclosure makes it possible to inhibit the agglomeration of the second particles present on the surface of the first particles, and as a result suppress the increase of impedance after charge/discharge cycles.

### BRIEF DESCRIPTION OF DRAWINGS

FIG. 1 is a representation schematically illustrating a positive electrode active material as an example of the embodiments.

FIG. 2 is a representation schematically illustrating the first particles contained in a positive electrode active material as an example of the embodiments.

FIG. 3 is a representation for describing a method for measuring the average surface roughness of the first particles.

FIG. 4 is an electron microscope image of a positive electrode active material (Example 1) as an example of the embodiments.

FIG. 5A is a representation for describing a relation between the surface roughness of the first particles and the dispersiveness of the second particles.

FIG. 5B is a representation for describing a relation between the surface roughness of the first particles and the dispersiveness of the second particles.

FIG. 6 is a graph demonstrating the functional effect of each positive electrode active material as an example of the embodiments in comparison with a conventional positive electrode active material (Examples 1 and 3, Comparative Example 1).

FIG. 7 is an electron microscope image of a conventional positive electrode active material (Comparative Example 1).

FIG. 8 is a representation schematically illustrating composite oxide particles (first particles) contained in a conventional positive electrode active material.

### DESCRIPTION OF EMBODIMENTS

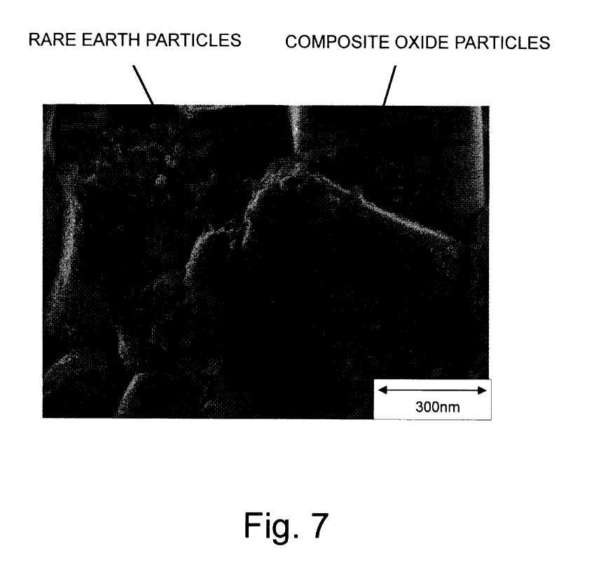

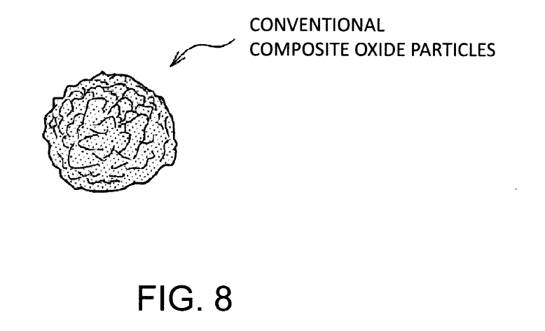

FIG. 7 is an electron microscope image of a conventional positive electrode active material. FIG. 8 is a representation schematically illustrating composite oxide particles contained in a conventional positive electrode active material. It can be seen from FIG. 7 that the rare earth particles attached on the surface of the composite oxide particles agglomerate. The present inventors thought that the agglomeration of the rare earth particles caused the increase of impedance in a part where an excessive amount of the rare earth element is present, resulting in difficulty in charging/discharging, and that this phenomenon was the main cause for the occurrence of the above problem. In addition, it is believed that the agglomeration of the rare earth particles generates many portions having no rare earth particles on the surface of the composite oxide particles, and as a result a surface-modifying effect owing to the rare earth particles cannot be obtained sufficiently.

Accordingly, the present inventors tried solving the above problem by inhibiting the agglomeration of rare earth particles on the surface of composite oxide particles. More specifically, the present inventors thought that the agglomeration of rare earth particles could be inhibited by reducing the surface unevenness of composite oxide particles (see FIG. 8).

An example of the embodiments will now be described in detail.

A nonaqueous electrolyte secondary battery as an example of the embodiments includes a positive electrode, a negative electrode and a nonaqueous electrolyte. A separator is preferably provided between the positive electrode and the negative electrode. The nonaqueous electrolyte secondary battery has a structure in which a wound-type electrode compartment having a positive electrode and a negative electrode being wound with a separator sandwiched therebetween, and a nonaqueous electrolyte, are contained in an outer package, for example. Alternatively, an electrode compartment having another configuration such as a stacked-type electrode compartment in which a positive electrode and a negative electrode are stacked with a separator sandwiched therebetween may be applied in place of the wound-type electrode compartment. The configuration of the nonaqueous electrolyte secondary battery is not particularly limited, and examples thereof include a cylinder type, a rectangular type, a coin type, a button type and a laminated type.

### Positive Electrode

The positive electrode includes a positive electrode current collector such as a metal foil and a positive electrode active material layer formed on the positive electrode current collector, for example. For the positive electrode current collector, a foil of a metal such as aluminum which is stable within an electric potential range in the positive electrode, a film in which the metal is disposed in the surface layer, or the like, may be used. The positive electrode active material layer preferably contains an electroconductive material and a binder in addition to a positive electrode active material. For the positive electrode active material, a positive electrode active material 10 described later is used.

The electroconductive material is used for enhancing the electroconductivity of the positive electrode active material layer. Examples of the electroconductive material include carbon materials such as carbon black, acetylene black, Ketjen black and graphite. One of them may be used singly, or two or more thereof may be used in combination.

The binder is used for maintaining a good contact state between the positive electrode active material and the electroconductive material and enhancing the binding properties of the positive electrode active material or the like to the surface of the positive electrode current collector. Examples of the binder include polytetrafluoroethylene (PTFE), polyvinylidene fluoride (PVdF) and modified products thereof. The binder may be used in combination with a thickener such as carboxymethyl cellulose (CMC) and polyethylene oxide (PEO). One of them may be used singly, or two or more thereof may be used in combination.

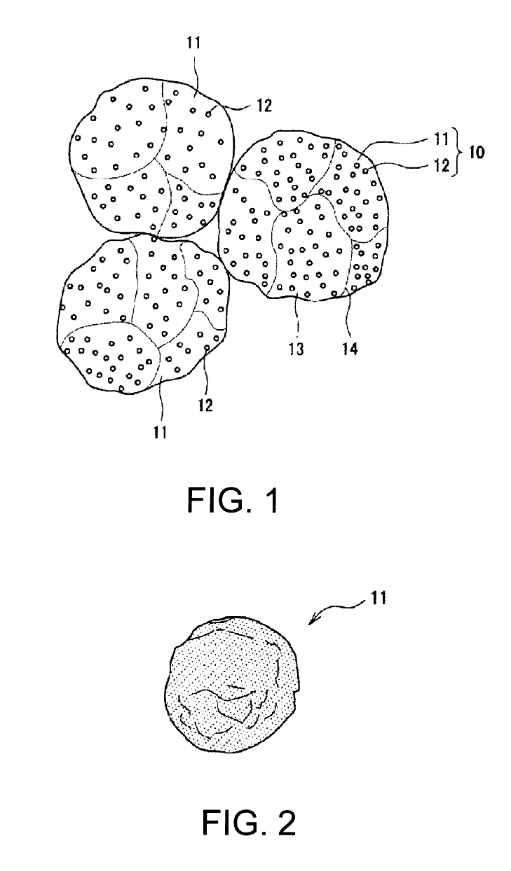

Now, the positive electrode active material 10 as an example of the embodiments will be described in detail with reference to FIGS. 1 to 5.

FIGS. 1 and 2 are representations schematically illustrating the positive electrode active material 10 and the first particle 11, respectively.

The positive electrode active material 10 includes the first particles 11 and the second particles 12 present on the surface of the first particles 11. The first particles 11 contain, as a main component, a lithium-nickel composite oxide (hereinafter, referred to as “composite oxide₁₁”) wherein the percentage of Ni relative to the total number of moles of a metal element other than Li is 30% by mole or more. The first particles 11 are particles having a surface with small unevenness, and the average surface roughness is 4% or less. The second particles 12 contain, as a main component, at least one selected from a hydroxide and an oxyhydroxide of a lanthanoid element (excluding La and Ce).

The content of the second particles 12 in the positive electrode active material 10 in terms of the lanthanoid element is preferably 0.005 to 0.8% by mass, more preferably 0.008 to 0.5% by mass and particularly preferably 0.1 to 0.3% by mass based on the mass of the first particles 11. If the content of the second particles 12 is within the range, good cycle characteristics can be obtained without lowering the discharge rate characteristics.

The positive electrode active material 10 may include a component other than the first particles 11 and the second particles 12 in a range which is not contrary to the advantage of the present invention. However, the first particles 11 and the second particles 12 are preferably contained in a quantity of 50% by mass or more based on the total mass of the positive electrode active material 10, and may be contained in a quantity of 100% by mass. The surface of the positive electrode active material 10 may be covered with fine particles of an inorganic compound such as an oxide such as aluminum oxide (Al₂O₃), a phosphate compound and a borate compound.

The composite oxide₁₁ as the main component of the first particles 11 is preferably a composite oxide represented by the general formula LiₓNi_{y}M₁₋ₓO₂ (wherein, 0.1≦x≦1.2; 0.3<y<1; and M denotes at least one metal element). From the viewpoints of cost reduction, higher capacity and the like, the content of Ni y is preferably set to at least more than 0.3. The composite oxide₁₁ has a layered rock salt type crystalline structure. The content of the composite oxide₁₁ in the first particles 11 is more than 50% by mass and preferably 100% by mass. In the following description, it is assumed that the first particles 11 consist only of the composite oxide₁₁ (100% by mass).

Examples of the metal element M contained in the composite oxide₁₁ include Co, Mn, Mg, Zr, Mo, W, Al, Cr, V, Ce, Ti, Fe, K, Ga and In. Among them, at least one of Co and Mn is preferably contained. Particularly from the viewpoints of cost reduction, improved safety and the like, at least Mn is preferably contained. Preferred examples of the composite oxide₁₁ include LiNi_{0.35}Mn_{0.35}Co_{0.3}O₂ and LiNi_{0.33}Mn_{0.33}Co_{0.33}O₂. One of the composite oxides₁₁ may be used singly, or two or more thereof may be used in combination.

The composite oxide₁₁ can also be synthesized from a lithium raw material in the same way as in the case of conventionally known lithium composite transition metal oxides (such as LiCoO₂ and LiNi_{0.33}Mn_{0.33}Co_{0.33}O₂). However, it is necessary in the conventional synthesizing method to set the amount of Li to be excessive to some extent and set the calcination temperature to 700 to 900° C. in order to obtain a layered rock salt phase as a stable phase. A calcination temperature of lower than 700° C. results in an insufficient crystal growth, and a calcination temperature of higher than 900° C. causes site exchange between an Ni ion and an Li ion (cation mixing) to allow an Ni ion to enter into an Li site and as a result may generate distortion of the crystalline structure to deteriorate battery characteristics. Synthesizing the composite oxides₁₁ while controlling the calcination temperature in this way is more difficult than producing a conventionally known lithium composite transition metal oxide from a lithium raw material in the same way.

A preferred method for synthesizing the composite oxide₁₁ is a method in which a sodium-nickel composite oxide is synthesized and thereafter the Na in the composite oxide is ion-exchanged for Li. A sodium-nickel composite oxide is synthesized from a sodium raw material and a nickel raw material. In synthesizing a sodium-nickel composite oxide, setting the calcination temperature to 600 to 1100° C. makes it possible to obtain a sodium-nickel composite oxide having no distortion of crystalline structure. In addition, the lithium-nickel composite oxide (composite oxide₁₁) obtained by ion-exchanging a sodium-nickel composite oxide forms particles which are generally spherical and have an average surface roughness of 4% or less, as described in detail later.

In a method utilizing ion-exchange, a layered rock salt phase can be obtained and the physical properties and crystal size of a product to be synthesized can be controlled even if the calcination temperature for a sodium-nickel composite oxide and the amount of Na therein are largely changed, in contrast to a method for synthesizing a lithium-nickel composite oxide from a lithium raw material. A composite oxide containing Ni tends to have a smaller primary particle diameter (e.g., less than 1 μm) and forms particles having a large surface roughness. However, the above method make it possible to control the particle shape because crystal growth occurs without the distortion or collapse of crystalline structure in calcination.

A method for synthesizing a sodium-nickel composite oxide is as follows.

For the sodium raw material, at least one selected from metal sodium and a sodium compound is used. The sodium compound which may be used is not particularly limited as long as it contains Na. Preferred examples of the sodium raw material include oxides such as Na₂O and Na₂O₂; salts such as Na₂CO₃ and NaNO₃; and hydroxides such as NaOH. Among them, NaNO₃ is particularly preferred.

The nickel raw material which may be used is not particularly limited as long as it is a compound containing Ni. Examples thereof include oxides such as Ni₃O₄, Ni₂O₃ and NiO₂; salts such as NiCO₃ and NiCl₂; hydroxides such as Ni(OH)₂; and oxyhydroxides such as NiOOH. Among them, NiO₂ and Ni(OH)₂ are particularly preferred.

The mixing ratio of the sodium raw material to the nickel raw material is preferably a ratio which allows a layered rock salt type crystalline structure to be generated. Specifically, the amount of sodium z in the general formula Na₂NiO₂ is preferably 0.5 to 2, more preferably 0.8 to 1.5 and particularly preferably 1. For example, both raw materials are mixed together so as to achieve the chemical composition of NaNiO₂. The method for mixing is not particularly limited as long as it enables homogenous mixing of the raw materials, and mixing may be carried out by using a known mixing machine such as a mixer.

The mixture of the sodium raw material and the nickel raw material is calcined in the atmosphere or in an oxygen gas flow. The calcination temperature is preferably 600 to 1100° C. as described above and more preferably 700 to 1000° C. The calcination time is preferably 1 to 50 hours when the calcination temperature is 600 to 1100° C. When the calcination temperature is 900 to 1000° C. the calcination time is preferably 1 to 10 hours. The calcined product is preferably pulverized by using a known method. In this way, a sodium-nickel composite oxide can be obtained.

A method for ion-exchanging a sodium-nickel composite oxide is as follows.

Preferred examples of a method for ion-exchanging Na for Li include a method in which a molten salt bed of a lithium salt is added to a sodium composite transition metal oxide and the resultant is heated. For the lithium salt, at least one selected from lithium nitrate, lithium sulfate, lithium chloride, lithium carbonate, lithium hydroxide, lithium iodide, lithium bromide and the like is preferably used. The heating temperature in an ion-exchanging treatment is preferably 200 to 400° C. and more preferably 330 to 380° C. The treatment time is preferably 2 to 20 hours and more preferably 5 to 15 hours.

For the method for ion-exchanging treatment, a method in which a sodium-containing transition metal oxide is soaked in a solution containing at least one lithium salt is also suitable. In this case, a sodium composite transition metal oxide is charged into an organic solvent with a lithium compound dissolved therein and treated at a temperature lower than or equal to the boiling point of the organic solvent. The ion-exchanging treatment is preferably performed while refluxing a solvent at a temperature near the boiling point of the organic solvent in order to increase the ion-exchange rate. The treatment temperature is preferably 100 to 200° C. and more preferably 140 to 180° C. The treatment time, although varying depending on the treatment temperature, is preferably 5 to 50 hours and more preferably 10 to 20 hours.

In the lithium-nickel composite oxide prepared by utilizing the ion-exchange, a certain amount of Na may be left due to the incomplete progression of the ion-exchange. In this case, the lithium-nickel composite oxide is represented by the general formula LiₓᵤNaₓ₍₁₋ᵤ₎Ni_{y}M_{1-y}O₂ (wherein, 0.1≦x≦1.2; 0.3<y<1; and 0.95<u≦1), for example. Here, u is the exchange rate in ion-exchanging Na for Li. Examples of completely ion-exchanged (u=1) lithium-nickel composite oxides include LiNi_{0.35}Co_{0.35}Mn_{0.3}O₂.

The composite oxide₁₁ prepared by utilizing the ion-exchange forms particles which are generally spherical and have a surface with small unevenness. The particles of the composite oxide₁₁ are secondary particles in which primary particles 13 agglomerate together. The secondary particles correspond to the first particles 11. The crystallite of the composite oxide₁₁ constitutes the primary particles 13, and the primary particles 13 agglomerate together to form the first particles 11 as secondary particles. Therefore, the particle boundary 14 of the primary particles 13 are present in the first particles 11. The first particles 11 may agglomerate in some cases, and the agglomerate of the first particles 1 can be separated apart from each other by using ultrasonic dispersion. On the other hand, the first particles 11 are never separated into the primary particles 13 even when being subjected to ultrasonic dispersion.

The volume average particle diameter (hereafter, denoted as “D₅₀”) of the first particles 11 (secondary particle) is preferably 7 to 30 μm and more preferably 8 to 15 μm. If the D₅₀ is within the range, the packing density in preparing a positive electrode is improved and the surface roughness of the first particles 11 tends to become smaller, for example. The D₅₀ of the first particles 11 can be measured by using a light diffraction/scattering method. D₅₀ refers to a particle diameter at which a volume-integrated fraction in a particle diameter distribution reaches 50%, and is also referred to as median diameter.

The particle diameter of the primary particles 13 forming the first particles 11 (hereinafter, referred to as “primary particle diameter”) is preferably 1 to 5 μm. If the primary particle diameter is within the range, the surface roughness of the first particles 11 can be reduced while maintaining the D₅₀ within a proper range. The primary particle diameter can be evaluated by using a scanning electron microscope (SEM). Specifically, the procedure is as follows:

(1) selecting 10 particles at random from a particle image obtained by observation of the first particles 11 with an SEM (2000×);

(2) observing the selected 10 particles for the particle boundary and so on to determine primary particles for each of them; and

(3) calculating the longest diameter for the primary particles to obtain the average value for the 10 particles, the average value is employed as the primary particle diameter.

The average surface roughness of the first particles 11 is 4% or less and preferably 3% or less. If the average surface roughness is 4% or less, the dispersiveness of the second particles 12 on the surface of the first particles 11 is improved, as described in detail later. From the viewpoint of improving the dispersiveness of the second particles 12, the first particles 11 preferably have a smaller surface roughness, and a particular lower limit thereof does not exist. The surface roughness of the first particles 11 is affected by the primary particle diameter and the closeness among the primary particles 13, for example.

Preferably, 90% or more of the first particles 11 have a surface roughness of 4% or less, for example, and more preferably 95% or more of the first particles 11 have a surface roughness of 4% or less. That is, the proportion of first particles 11 having a surface roughness of 4% or less is preferably 90% or more based on the total quantity of the first particles 11.

The average surface roughness of the first particles 11 is evaluated by determining the surface roughness particle by particle. The surface roughness was determined for 10 particles and the average value was employed as the average surface roughness. The surface roughness (%) is calculated by using a calculation formula for surface roughness described in International Publication No. WO 2011/125577. The calculation formula is as follows:

(surface roughness)=(maximum value among variations of particle radius r every 1° interval)/(longest diameter of particle)

The particle radius r was determined in a shape measurement described later as the distance from the center C, which is defined as the point at which the longest diameter of the particle is bisected, to a point in the periphery of the particle. Variations of the particle radius every 1° interval are each an absolute value, and the maximum value among them refers to the maximum among variations measured for the entire periphery of the particle every 1° interval.

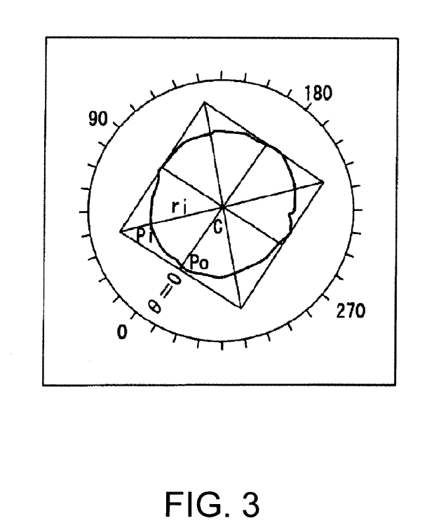

FIG. 3 is a representation illustrating the periphery shape of a first particle 11 based on an SEM image of the particle.

In FIG. 3, the distance from the center C to the point Pᵢ in the periphery of the particle is measured as the particle radius rᵢ. The center C is the position at which the longest diameter of the particle is bisected. A position in the periphery of the particle at which the particle radius r corresponds to the maximum was employed as a reference point P₀ (θ=0). The angle between the line segment CP₀ from the reference point P₀ to the center C and the line segment CPᵢ from another point Pᵢ in the periphery of the particle to the center C was defined as θ. Thus, each particle radius r was determined at θ every 1° interval. The surface roughness was calculated in accordance with the above calculation formula by using these particle radiuses r.

The degree of circularity of the first particles 11 is preferably 0.9 or more. Preferably, 90% or more of the first particles 11 have a degree of circularity of 0.9 or more, for example, and more preferably 95% or more of the first particles 11 have a degree of circularity of 0.9 or more. That is, the proportion of a first particles 11 having a degree of circularity of 0.9 or more is preferably 90% or more based on the total quantity of the first particles 11. The degree of circularity is an indicator of the degree of sphericalness when the first particle 11 is projected onto a two-dimensional plane, and a degree of circularity near 1 is preferred because the packing density of an active material in preparing a positive electrode is improved as the degree of circularity approaches 1.

For determination of the degree of circularity of a first particle 11, a particle as a sample is placed in a measurement system and a particle image is taken with the sample stream irradiated with a stroboscopic light and the degree of circularity is determined on the basis of the particle image. The calculation formula for degree of circularity is as follows:

(degree of circularity)=(perimeter of circle having same area as particle image)/(perimeter of particle image)

The perimeter of a circle having the same area as a particle image and the perimeter of the particle image can be determined by subjecting the particle image to image processing. When a particle image represents a true circle, the degree of circularity is 1.

The second particles 12 are present on the surface of the first particles 11, as described above. The particle diameter of the second particles 12 is smaller than that of the first particles 11 as described later, and the content of the second particles 12 in terms of lanthanoid element is preferably 0.005 to 0.8% by mass based on the mass of the first particle 11. Therefore, the second particles 12 are present on a part of the surface of the first particles 11 and do not cover the whole surface of the first particle 11. As described in detail later, the second particles 12 are ubiquitously present on the surface of the first particles 11 with little agglomeration.

The second particles 12 preferably adhere to the surface of the first particles 11. Adhering refers to a state in which the second particles 12 are strongly bonded to the surface of the first particles 11 and are not separated apart easily, and the second particles 12 are not detached from the surface of the first particles 11 even when the positive electrode active material 10 is subjected to ultrasonic dispersion, for example.

The hydroxide or oxyhydroxide of a lanthanoid element (excluding La and Ce) as the main component of the second particles 12 (hereinafter, occasionally referred to as “lanthanoid (oxy)hydroxide”) is a hydroxide or an oxyhydroxide of praseodymium (Pr), neodymium (Nd), promethium (Pm), samarium (Sm), europium (Eu), gadolinium (Gd), terbium (Tb), dysprosium (Dy), holmium (Ho), thulium (Tm), erbium (Er), ytterbium (Yb) or lutetium (Lu). A lanthanoid element (excluding La and Ce) is, in other words, one of the rare earth elements of atomic numbers 59 to 71.

The reduction of discharge voltage and discharge capacity after charge/discharge cycles can be suppressed by allowing the second particles 12 to adhere to the surface of the first particles 11. Although the mechanism is not clear, the reason is probably that the lanthanoid (oxy)hydroxide improves the stability of the crystalline structure of the composite oxide₁₁. If the stability of the crystalline structure of the composite oxide₁₁ is improved, the change in crystalline structure in charge/discharge cycles is inhibited and the increase of interfacial reaction resistance when an Li ion is intercalated or eliminated can be suppressed.

The lanthanoid (oxy)hydroxide as the main component of the second particles 12 is preferably a hydroxide or an oxyhydroxide of Pr, Nd or Er. Among them, the lanthanoid (oxy)hydroxide is more preferably at least one selected from praseodymium hydroxide, neodymium hydroxide, erbium hydroxide, neodymium oxyhydroxide and erbium oxyhydroxide. Hydroxides and oxyhydroxides of La and Ce are unstable and easily transformed into an oxide. Owing to this fact, the reduction of discharge voltage and discharge capacity cannot be sufficiently suppressed when a hydroxide or oxyhydroxide of La or Ce is used.

The content of the lanthanoid compound in the second particles 12 is more than 50% by mass and preferably 100% by mass. In the following description, it is assumed that the second particles 12 consist only of a lanthanoid compound (100% by mass).

The particle diameter of the second particles 12 is preferably 100 nm or less and more preferably 50 nm or less. Preferably, 90% or more of the second particles 12 have a particle diameter of 50 nm or less, for example, and more preferably, 95% or more of the second particles 12 have a particle diameter of 50 nm or less. That is, the proportion of the second particles 12 having a particle diameter of 50 nm or less is preferably 90% or more based on the total quantity of the second particles 12. If the second particles 12 having a particle diameter of 50 nm or less are present on the surface of the first particles 11 in a large quantity, the surface-modifying effect due to a lanthanoid (oxy)hydroxide can be sufficiently obtained.

The particle diameter of a second particle 12 refers to the longest diameter of an object which is present on the surface of a first particle 11 as an independent particulate unit. This means that the particle diameter is large if the second particle 12 is present in an agglomerate. The particle diameter can be determined on the basis of an SEM image of the positive electrode active material 10.

On the surface of the first particles 11, the second particles 12 are present in portions other than the particle boundary 14 of the primary particles 13 in a larger quantity than in the particle boundary 14. That is, the quantity of the second particles 12 being in contact with one primary particle 13 is larger than that of the second particles 12 being in contact with two primary particles 13. The second particles 12 are present generally homogeneously on the surface of the first particles 11 without being localized in a part of the surface. The second particles 12 tend to agglomerate in concave portions in the surface of the first particles 11. However, the first particles 11 have a surface with small unevenness even in the particle boundary 14, and therefore the agglomeration of the second particles 12 is inhibited even in the particle boundary 14. In the case of a conventional positive electrode active material illustrated in FIG. 7, rare earth particles are present in a large quantity and agglomerates in a particle boundary of a composite oxide particle and the quantity of the rare earth particles present in a portion other than the particle boundary is small.

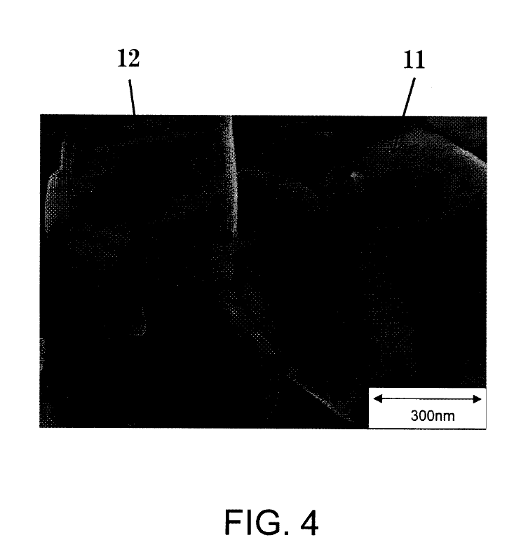

FIG. 4 is an SEM image of the positive electrode active material 10.

It can be seen from FIG. 4 that the second particles 12 present on the surface of the first particle 11 hardly agglomerate and the dispersiveness of the second particles 12 is high. In the positive electrode active material 10 shown in FIG. 4, the content of the second particles 12 relative to the first particles 11 is the same as the content of the rare earth particles illustrated in FIG. 7. That is, the content of the second particles 12 relative to the first particles 11 is approximately equal to the content of the rare earth particles relative to the composite oxide particles. The second particles 12 cannot be identified clearly in the SEM image in FIG. 4, and this is because the particle diameter is as small as 50 nm or less for most of the second particles 12. The second particles 12 are dispersed generally homogeneously on the surfaces of the first particles 11.

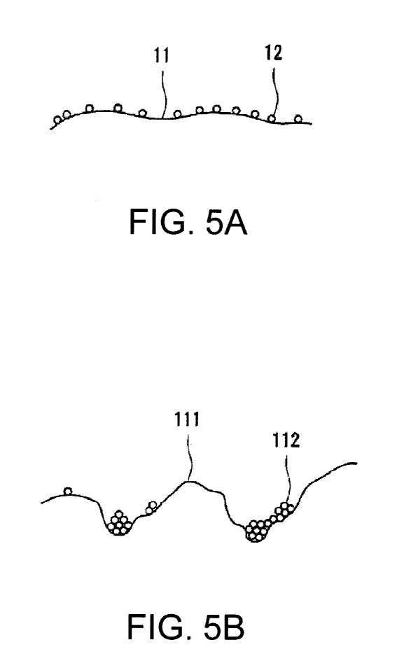

FIGS. 5A and 5B are each a representation illustrating a relation between the surface roughness of the first particle and the dispersiveness of the second particle.

FIG. 5B illustrates a conventional first particle 111, which has a large surface roughness. Large unevenness is formed in the surface of the first particle 111, and second particles 112 are accumulated in a large quantity and agglomerate in the concave portion in the surface. Due to this, the second particles 112 concentrate locally and a portion in which almost no second particles 112 are present is generated. FIG. 5A illustrates a first particle 11 having a smooth surface. No such large unevenness that allows second particles 12 to accumulate is present on the surface of the first particle 11. Therefore, the agglomeration of the second particles 12 is significantly inhibited on the surface of the first particle 11 and this helps the second particles 12 to disperse homogeneously.

Examples of a method for allowing the second particles 12 to adhere to the surface of the first particles 11 include a method in which a solution with the first particles 11 dispersed therein is mixed into a solution with a lanthanoid compound dissolved therein and a method in which, while stirring the first particles 11, a solution with a lanthanoid compound dissolved therein is sprayed on the first particles 11. For the lanthanoid compound, an acetate, nitrate, sulfate, oxide, chloride or the like of a lanthanoid may be used. If the first particles 11 to which a lanthanoid hydroxide has adhered is heat-treated at a predetermined temperature, the hydroxide is transformed into a lanthanoid oxyhydroxide.

The second particles 12 preferably contain no lanthanoid oxide. If active material particles having a hydroxide of a rare earth element on the surface are heat-treated, the hydroxide is transformed into an oxyhydroxide or an oxide, and in general the temperature at which a hydroxide or an oxyhydroxide of a rare earth element is stably transformed into an oxide is 500° C. or higher. If heat treatment is performed at such a temperature, a part of the compound of a rare earth element may diffuse to the inside of the active material to deteriorate the effect of inhibiting the change in crystalline structure in the surface.

### Negative Electrode

The negative electrode includes a negative electrode current collector such as a metal foil and a negative electrode active material layer formed on the negative electrode current collector, for example. A foil of a metal such as aluminum and copper which is stable within an electric potential range in the negative electrode, a film in which the metal is disposed in the surface layer, or the like may be used for the negative electrode current collector. The negative electrode active material layer preferably contains a binder in addition to a negative electrode active material capable of occluding/discharging lithium ions. Further, the negative electrode active material layer may contain an electroconductive material, as necessary.

Examples of the negative electrode active material which may be used include natural graphite, artificial graphite, lithium, silicon, carbon, tin, germanium, aluminum, lead, indium, gallium and lithium alloys; carbon and silicon with lithium occluded therein in advance; and alloys and mixtures thereof. Although PTFE or the like may be used for the binder as in the case of the positive electrode, a styrene-butadiene copolymer (SBR), a modified product thereof or the like is preferably used. The binder may be used in combination with a thickener such as CMC.

### Nonaqueous Electrolyte

The nonaqueous electrolyte contains a nonaqueous solvent and an electrolyte salt dissolved in the nonaqueous solvent. The nonaqueous electrolyte is not limited to a liquid electrolyte (nonaqueous electrolytic solution), and may be a solid electrolyte using a gelled polymer or the like. Examples of the nonaqueous solvent which may be used include esters; ethers; nitriles such as acetonitrile; amides such as dimethylformamide; and mixed solvents of two or more thereof. The nonaqueous solvent may contain a halogen-substituted product obtained by substituting a hydrogen in one of these solvents with a halogen atom such as fluorine. The halogen-substituted product is preferably a fluorinated cyclic carbonate or a fluorinated chain carbonate, and more preferably a mixture of them is used.

Examples of the esters include cyclic carbonates such as ethylene carbonate, propylene carbonate and butylene carbonate; chain carbonates such as dimethyl carbonate, methyl ethyl carbonate, diethyl carbonate, methyl propyl carbonate, ethyl propyl carbonate and methyl isopropyl carbonate; and carboxylates such as methyl acetate, ethyl acetate, propyl acetate, methyl propionate, ethyl propionate and γ-butyrolactone.

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol and crown ethers; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether and tetraethylene glycol dimethyl.

The electrolyte salt is preferably a lithium salt. Examples of the lithium salt include LiPF₆, LiBF₄, LiAsF₆, LiClO₄, LiCF₃SO₃, LiN(FSO₂)₂, LiN(C₁F₂₁₊₁SO₂) (CₘF₂ₘ₊₁SO₂) (l and m each denote an integer of 1 or more), LiC(C_{P}F₂ₚ₊₁SO₂) (C_{q}F_{2q+1}SO₂) (CᵣF₂ᵣ₊₁SO₂) (p, q and r each denote an integer of 1 or more), Li[B(C₂O₄)₂] (lithium bis(oxalate) borate (LiBOB)), Li[B(C₂O₄)F₂], Li[P(C₂O₄)F₄] and Li[P(C₂O₄)₂F₂]. One of these lithium salts may be used singly, or two or more thereof may be used in combination.

### Separator

A porous sheet having ion permeability and insulating properties is used for the separator. Specific examples of the porous sheet include a microporous thin film, a woven fabric and a nonwoven fabric. The material for the separator is preferably cellulose or an olefin resin such as polyethylene and polypropylene. The separator may be a laminate including a cellulose fiber layer and a thermoplastic resin fiber layer formed of an olefin resin or the like.

### EXAMPLES

The present invention will now be described further by using Examples, but the present invention is never limited to these Examples.

### Example 1

### Preparation of Positive Electrode Active Material

Sodium nitrate (NaNO₃), nickel (II) oxide (NiO), cobalt (II, III) oxide (CO₃O₄) and manganese (III) oxide (Mn₂O₃) were mixed together so as to achieve Na_{0.95}Ni_{0.35}Co_{0.35}Mn_{0.3}O₂ (composition to charge). This mixture was retained at a calcination temperature of 850° C. for 35 hours to afford a sodium-nickel composite oxide.

To 5 g of the sodium-nickel composite oxide obtained, a molten salt bed in which lithium nitrate (LiNO₃) and lithium hydroxide (LiOH) had been mixed together so as to achieve a molar ratio of 61:39 was added in an amount of 5 equivalents (25 g). Thereafter, 30 g of this mixture was retained at a calcination temperature of 200° C. for 10 hours for ion-exchange of the Na in the sodium-nickel composite oxide for Li. The substance alter the ion-exchange was further washed with water to obtain a lithium-nickel composite oxide.

The lithium-nickel composite oxide obtained was analyzed for identification of crystalline structure in accordance with a powder X-ray diffraction (XRD) method by using powder XRD measurement apparatus (manufactured by Rigaku Corporation; trade name: “RINT 2200”; radiation source: Cu-Kα). The crystalline structure obtained was found to be a layered rock salt type crystalline structure. Further, the composition of the lithium-nickel composite oxide was measured in accordance with inductively-coupled plasma (ICP) optical emission spectrometry by using an ICP optical emission spectrometer (manufactured by Thermo Fisher Scientific Inc.; trade name: “iCAP 6300”) and found to be Li_{0.95}Ni_{0.35}Co_{0.35}Mn_{0.3}O₂.

The lithium-nickel composite oxide obtained was classified and a classified product having a D₅₀ of 7 to 30 μm was used for first particles A1. To the surface of the first particles A1 second particles B1 were allowed to adhere to prepare a positive electrode active material C1 by using the following procedure.

(1) To 3 L of pure water, 1000 g of the first particles A1 were added to prepare a suspension with the first particles A1 dispersed therein.

(2) To the suspension, a solution with 1.05 g of erbium nitrate pentahydrate [Er(NO₃)₃.5H₂O] dissolved in 200 mL of pure water was added. Then, 10% by mass aqueous solution of nitric acid or 10% by mass aqueous solution of sodium hydroxide was appropriately added to adjust the pH of the solution with the first particles A1 dispersed therein to 9.

(3) After the addition of the solution of erbium nitrate pentahydrate was completed, the resultant was subjected to suction filtration and washed with water to obtain a powder, and then the powder was dried at 120° C. to afford a powder in which erbium hydroxide adhered to a parts of the surfaces of the first particles A1.

(4) The powder obtained was heat-treated in an air at 300° C. for 5 hours. This heat treatment allows the erbium hydroxide to be transformed into erbium oxyhydroxide. However, a part of the erbium hydroxide may remain untransformed.

Thus, a positive electrode active material C1 was obtained in which the second particles B1, as fine particles of erbium oxyhydroxide (a part thereof may be erbium hydroxide), adhered to the surfaces of the first particles A1. Hereinafter, erbium oxyhydroxide and erbium hydroxide contained in the second particles B1 are collectively referred to as an erbium compound (the same applies for other lanthanoid compounds).

The quantity of the second particles B1 as an erbium compound in the positive electrode active material C1 adhering was measured by using the above ICP optical emission spectrometer and found to be 0.3% by mass in terms of erbium element relative to the first particles A1. FIG. 3 shows an SEM image of the positive electrode active material C1. As described above, almost no agglomerations of the second particles B1 were found on the surface of the positive electrode active material C1.

### Preparation of Positive Electrode

The positive electrode active material C1, a carbon powder and a polyvinylidene fluoride powder were mixed together so that their contents were 92% by mass, 5% by mass and 3% by mass, respectively, and the resultant was mixed with an N-methyl-2-pyrrolidone (NMP) solution to prepare a slurry. This slurry was applied onto both surfaces of an aluminum collector with a thickness of 15 μm by using a doctor blade method to form a positive electrode active material layer. The resultant was then compressed with a compression roller, cut out in a predetermined size, and thereafter a positive electrode tab was attached thereon to obtain a positive electrode having a short side length of 30 mm and a long side length of 40 mm.

### Preparation of Negative Electrode

A negative electrode active material, a styrene-butadiene copolymer and carboxymethyl cellulose were mixed together so that their contents were 98% by mass, 1% by mass and 1% by mass, respectively, and this was mixed with water to prepare a slurry. For the negative electrode active material, a mixture of natural graphite, artificial graphite and artificial graphite with the surface covered with amorphous carbon was used. This slurry was applied onto both surfaces of a copper collector with a thickness of 10 μm by using a doctor blade method to form a negative electrode active material layer. The resultant was then compressed with a compression roller, cut out in a predetermined size, and thereafter a negative electrode tab was attached thereon to obtain a negative electrode having a short side length of 32 mm and a long side length of 42 mm.

### Preparation of Nonaqueous Electrolytic Solution

LiPF₆ was dissolved in a nonaqueous solvent in which ethylene carbonate (EC) and diethyl carbonate (DEC) had been mixed together in an equal volume to a concentration of 1.6 mol/L to obtain a nonaqueous electrolytic solution.

### Preparation of Nonaqueous Electrolyte Secondary Battery

A nonaqueous electrolyte secondary battery was prepared with the above positive electrode, the above negative electrode, the above nonaqueous electrolytic solution and a separator by using the following procedure.

(1) The positive electrode and the negative electrode were wound with the separator sandwiched therebetween to prepare a wound electrode compartment.

(2) Insulating sheets were disposed on the top and bottom of the wound electrode compartment, respectively, and the wound electrode compartment was contained in a cylindrical battery outer package can having a diameter of 18 mm and a height of 65 mm. The battery outer package can was made of steel and also served as a negative electrode terminal.

(3) The negative electrode current collector tab was welded to the inner bottom of the battery outer package can and simultaneously the positive electrode current collector tab was welded to the bottom plate of a current-interrupting sealing member with a safety device installed thereto.

(4) The nonaqueous electrolytic solution was supplied from the opening of the battery outer package can, and then sealed with a current-interrupting sealing member provided with a safety valve and a current-interrupting device to obtain a nonaqueous electrolyte secondary battery D1. The designed capacity of the nonaqueous electrolyte secondary battery D1 was 2400 mAh.

### Example 2

A positive electrode active material C2 was prepared in the same way as in Example 1 except that the amount of erbium nitrate pentahydrate to be added was changed so that the amount of the erbium compound (second particle B1) to adhere was 0.1% by mass in terms of erbium element relative to the first particles A1. Further, a nonaqueous electrolyte secondary battery D2 was prepared with the positive electrode active material C2 by using the same method as in Example 1.

### Example 3

A first particle A2 was prepared in the same way as in Example 1 except that the calcination temperature for the sodium-nickel composite oxide was changed to 800° C. Further, a positive electrode active material C3 and a nonaqueous electrolyte secondary battery D3 were prepared with the first particles A2 by using the same method as in Example 1.

### Example 4

A positive electrode active material C4 was prepared in the same way as in Example 3 except that the amount of erbium nitrate pentahydrate to be added was changed so that the amount of the erbium compound (second particles B1) to adhere was 0.1% by mass in terms of erbium element relative to the first particles A3. Further, a nonaqueous electrolyte secondary battery D4 was prepared with the positive electrode active material C4 by using the same method as in Example 1.

### Example 5

A nonaqueous electrolyte secondary battery D5 was prepared in the same way as in Example 1 except that second particles B2 containing a praseodymium compound were allowed to adhere to the surfaces of the first particles A1 to prepare a positive electrode active material C5. In this case, praseodymium nitrate hexahydrate was used in place of erbium nitrate pentahydrate in the step of allowing the second particles to adhere to the surfaces of the first particles A1.

The amount of the praseodymium compound adhering in the positive electrode active material C5 was measured by using the above ICP optical emission spectrometer and found to be 0.3% by mass in terms of praseodymium element relative to the first particles A1.

### Example 6

A positive electrode active material C6 was prepared in the same way as in Example 5 except that the amount of praseodymium nitrate hexahydrate to be added was changed so that the amount of the praseodymium compound (second particles B2) to adhere was 0.1% by mass in terms of praseodymium element relative to the first particles A1. Further, a nonaqueous electrolyte secondary battery D6 was prepared with the positive electrode active material C6 by using the same method as in Example 1.

### Comparative Example 1

First particles X1 were prepared in the same way as in Example 1 except that, in preparing a positive electrode active material, lithium nitrate (LiNO₃), nickel (IV) oxide (NiO₂), cobalt (II, III) oxide (Co₃O₄) and manganese (III) oxide (Mn₂O₃) were mixed together so as to achieve Li_{0.95}Ni_{0.35}Co_{0.35}Mn_{0.3}O₂, and the mixture was calcined at a calcination temperature of 600° C. and retained for 10 hours with intermittent breaks of calcination to prepare a sodium-nickel composite oxide. Further, a positive electrode active material Y1 and a nonaqueous electrolyte secondary battery Z1 were prepared with the first particles X1 by using the same method as in Example 1.

FIG. 7 shows an SEM image of the positive electrode active material Y1. As described above, it can be seen that the second particles B1 (rare earth particle) agglomerate on the surfaces of the first particles X1 as a composite oxide particle. Particularly, the second particles B1 agglomerate significantly in the particle boundary of primary particles constituting the first particles X1.

### Comparative Example 2

A positive electrode active material Y2 was prepared in the same way as in Comparative Example 1 except that the amount of erbium nitrate pentahydrate to be added was changed so that the amount of the erbium compound (second particles B1) to adhere was 0.1% by mass in terms of erbium element relative to the first particles X1. Further, a nonaqueous electrolyte secondary battery Z2 was prepared with the positive electrode active material Y2 by using the same method as in Example 1.

Each of the first particles prepared in Examples 1 to 6 and Comparative Examples 1 and 2 was evaluated for the D₅₀, primary particle diameter, average surface roughness and degree of circularity. The evaluation results are shown in Tables 1 and 2.

### Evaluation for D₅₀

The D₅₀ of a first particle was measured by using a laser diffraction/scattering particle size distribution analyzer (manufactured by HORIBA, Ltd.; trade name: “LA-750”) with water as a dispersion medium.

### Evaluation for Primary Particle Diameter

The procedure for measuring a primary particle diameter is as follows.

From a particle image obtained by observation with an SEM (2000×), 10 particles were selected at random. Next, each of the selected 10 particles was observed for the particle boundary and so on, and the primary particles for each of them were determined. The longest diameter among the primary particles was determined for the 10 particles, and the average value of them was employed as the primary particle diameter.

### Evaluation for Average Surface Roughness

The surface roughnesses determined for 10 particles were averaged, and the average value was employed as the average surface roughness. The surface roughness (%) was calculated by using the following calculation formula.

(surface roughness)=(maximum value among variations of particle radius r every 1° interval)/(longest diameter of particle)

The particle radius r was determined in the shape measurement described by using FIG. 3 as the distance from the center C, which is defined as the point at which the longest diameter of the particle is bisected, to a point on the periphery of the particle. Variations of the particle radius every 1° interval are each an absolute value, and the maximum value among them refers to the maximum among variations measured for the entire periphery of the particle every 1° interval.

### Evaluation for Degree of Circularity

The degree of circularity was measured by using a flow particle image analyzer (manufactured by Sysmex Corporation; trade name: “FPIA-2100”). For determination of the degree of circularity, a particle as a sample was placed in the measurement system and a static image was obtained with the sample stream irradiated with a stroboscopic light and the degree of circularity is determined on the basis of the static image. The number of particles to be evaluated was 5000 or more. For the dispersion medium, an ion-exchanged water with polyoxyrene sorbitan monolaurate as a surfactant added thereto was used. The principle and calculation formula for measuring degree of circularity are as described above.

Each of the positive electrode active materials prepared in Examples 1 to 6 and Comparative Examples 1 and 2 was evaluated for the dispersiveness of second particles adhering to the surfaces of first particles. The evaluation for the dispersiveness of second particles was on the basis of an SEM observation and the proportion of second particles having a particle diameter of 50 nm or less.

The evaluation results are shown in Tables 1 and 2.

### SEM Observation

A positive electrode active material was observed with an SEM (100000×) and checked for the presence/absence and degree of agglomeration of second particles, the localization of second particles and so on. The degree of agglomeration of second particles was determined as good or poor.

good: almost no agglomerations of second particles were found.

poor: many agglomerations of second particles were found.

### Proportion of Second Particles Having Particle Diameter of 50 nm or Less

From an SEM image (100000×) of a positive electrode active material, the longest diameter was determined for 20 second particles. The particle diameter of a second particle refers to the longest diameter of an object which is present on the surface of a first particle as an independent particulate unit. The proportion of second particles having a particle diameter of 50 nm or less was calculated relative to the total number (20) of the second particles determined for the particle diameter. It can be said that, the larger the proportion, the smaller the quantity of second particles agglomerating and as a result the higher the dispersiveness of second particles.

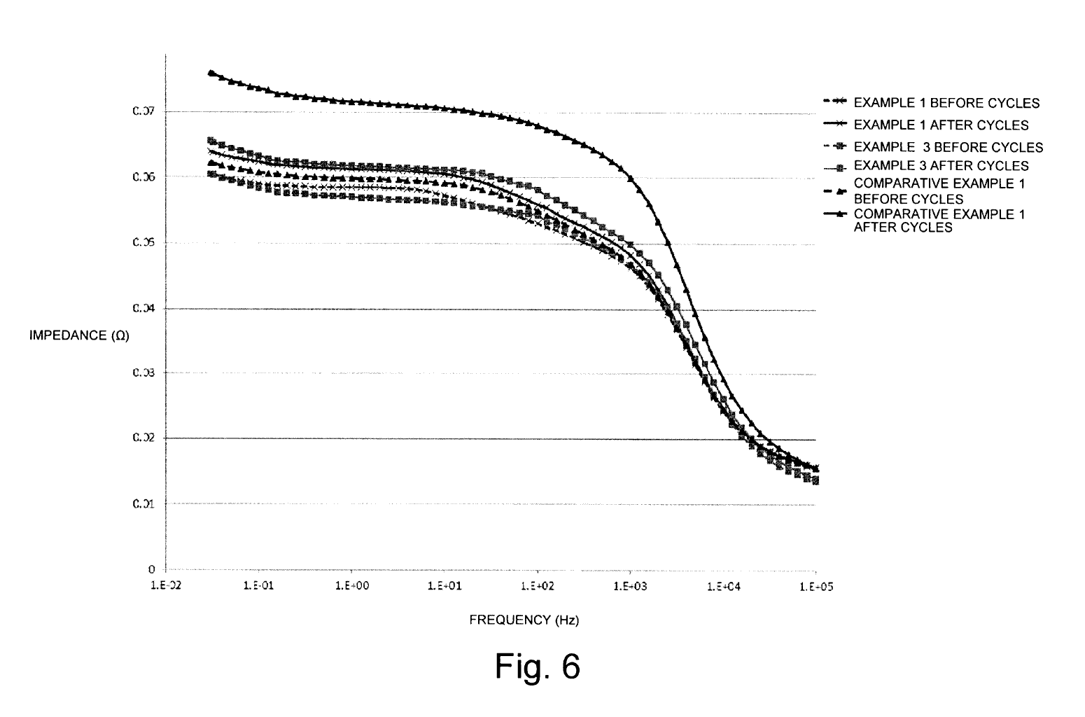

Each of the nonaqueous electrolyte secondary batteries prepared in Examples 1 to 6 and Comparative Examples 1 and 2 was evaluated for impedance before and after charge/discharge cycles. The evaluation results are shown in Tables 1 and 2 and FIG. 6. Note that the values of impedance in Tables 1 and 2 are each a representative value of impedance at 1 Hz.

### Measurement for Impedance

The impedance was measured by using an electrochemical measurement system (manufactured by Solartron Analytical; model name: “Model 1255”). For a sample, a nonaqueous electrolyte secondary battery with the quantity of electricity charged to half the designed capacity was used. For measuring the capacity impedance of a nonaqueous electrolyte secondary battery, a nonaqueous electrolyte secondary battery as a sample was placed in the measurement system and the sample was applied with an AC voltage, and the impedance value was measured at each frequency. The measurement was performed in a frequency range of 100 kHz to 0.03 Hz under conditions that the amplitude of the AC voltage was 10 mV and the temperature of the measurement system was 25° C. The impedance measurement was performed before the cycle test for a nonaqueous electrolyte secondary battery and after the completion of 400 cycles.

TABLE 1

| | | Example | Example | Example | Example | Example | Example |
|---|---|---|---|---|---|---|---|
| | | 1 | 2 | 3 | 4 | 5 | 6 |
| A | D₅₀ (μm) | 9.9 | 9.9 | 10.2 | 10.2 | 9.9 | 9.9 |
| | Primary | 1.5 | 1.5 | 1.0 | 1.0 | 1.5 | 1.5 |
| | particle | | | | | | |
| | diameter | | | | | | |
| | (μm) | | | | | | |
| | Surface | 2.9 | 2.9 | 4.0 | 4.0 | 2.9 | 2.9 |
| | roughness | | | | | | |
| | (%) | | | | | | |
| | Degree of | 0.91 | 0.91 | 0.90 | 0.90 | 0.91 | 0.91 |
| | circularity | | | | | | |
| B | Lanthanoid | Er | Er | Er | Er | Pr | Pr |
| | element | | | | | | |
| | Content (% | 0.3 | 0.1 | 0.3 | 0.1 | 0.3 | 0.1 |
| | by mass) *¹ | | | | | | |
| C | SEM | good | good | good | good | good | good |
| | observation *² | | | | | | |
| | 50 nm | 95 | 100 | 90 | 100 | 35 | 100 |
| | particle | | | | | | |
| | proportion | | | | | | |
| | (%) *³ | | | | | | |
| D | Impedance | 0.061 | 0.059 | 0.062 | 0.059 | 0.060 | 0.060 |
| | (Ω) (after | | | | | | |
| | cycles) | | | | | | |
| | Impedance | 0.058 | 0.058 | 0.057 | 0.058 | 0.059 | 0.057 |
| | (Ω) (before | | | | | | |
| | cycles) | | | | | | |
| | Increasing | 5.1 | 1.7 | 8.1 | 1.7 | 1.7 | 5.2 |
| | rate after | | | | | | |
| | cycles | | | | | | |

*¹ The content of a second particle (in terms of lanthanoid element) based on the mass of a first particle.
*² The degree of agglomeration of second particles was evaluated as good or poor by an SEM observation for a positive electrode active material.
*³ The proportion of second particles having a particle diameter of 50 nm or less.

TABLE 2

| | | Comparative | Comparative |
|---|---|---|---|
| | | Example 1 | Example 2 |
| X | D₅₀ (μm) | 10.0 | 10.0 |
| | Primary particle | 0.2 | 0.2 |
| | diameter (μm) | | |
| | Surface roughness | 5.0 | 5.0 |
| | (%) | | |
| | Degree of | 0.91 | 0.91 |
| | circularity | | |
| B | Lanthanoid | Er | Er |
| | element | | |
| | Content (% by | 0.3 | 0.1 |
| | mass) *¹ | | |
| Y | SEM observation *² | poor | poor |
| | 50 nm particle | 75 | 75 |
| | fraction (%) *³ | | |
| Z | Impedance (Ω) | 0.072 | 0.070 |
| | (after cycles) | | |
| | Impedance (Ω) | 0.059 | 0.058 |
| | (before cycles) | | |
| | Increasing rate | 22.0 | 20.6 |
| | after cycles | | |

As shown in Table 1, the positive electrode active materials in the examples each had a high proportion of second particles having a particle diameter of 50 nm or less and a high dispersiveness of second particles on the surfaces of first particles. On the other hand, the positive electrode active materials in the Comparative Examples each had a smaller proportion of second particles having a particle diameter of 50 nm or less than those in the Examples and had many agglomerations of second particles. As shown in FIG. 6, the increase of impedance after charge/discharge cycles was found to be largely different between the nonaqueous electrolyte secondary batteries in the Examples and those in the Comparative Examples. While the nonaqueous electrolyte secondary batteries in the Examples each had a small increase in impedance after 400 cycles, the nonaqueous electrolyte secondary batteries in the Comparative Examples each had a significant increase in impedance after 400 cycles. This result is considered to be due to the difference in the attachment state of second particles.

Although experimental data for the erbium compound and the praseodymium compound are presented in Examples, the cases where another lanthanoid (oxy)hydroxide is used are considered to provide the same effect.

### REFERENCE SIGNS LIST

10 positive electrode active material
11, 111 first particles
12, 112 second particles
13 primary particles
14 particle boundary

1. A positive electrode active material for nonaqueous electrolyte secondary batteries comprising:
first particles containing, as a main component, a lithium-nickel composite oxide wherein the percentage of Ni relative to a total number of moles of a metal element other than Li is more than 30% by mole, and having an average surface roughness of 4% or less; and
second particles containing, as a main component, at least one selected from a hydroxide and an oxyhydroxide of a lanthanoid element (excluding La and Ce), and present on surfaces of the first particles.

2. The positive electrode active material for nonaqueous electrolyte secondary batteries according to claim 1, wherein the first particles have a volume average particle diameter of 7 to 30 μm.

3. The positive electrode active material for nonaqueous electrolyte secondary batteries according to claim 1, wherein the lanthanoid element is at least one selected from praseodymium, neodymium and erbium.

4. The positive electrode active material for nonaqueous electrolyte secondary batteries according to claim 1, wherein a content of the second particles in terms of the lanthanoid element is 0.005 to 0.8% by mass based on a mass of the first particles.

5. The positive electrode active material for nonaqueous electrolyte secondary batteries according to claim 1, wherein 90% or more of the second particles have a particle diameter of 50 nm or less.

6. The positive electrode active material for nonaqueous electrolyte secondary batteries according to claim 1, wherein, on surfaces of the first particles, the second particles are present at portions other than a particle boundaries of primary particles constituting the first particles in a larger quantify than at the particle boundaries.

7. The positive electrode active material for nonaqueous electrolyte secondary batteries according to claim 1, wherein 90% or more of the first particles have a degree of circularity of 0.9 or more.

8. A nonaqueous electrolyte secondary battery comprising:
a positive electrode containing the positive electrode active material for nonaqueous electrolyte secondary batteries according to claim 1;
a negative electrode; and
a nonaqueous electrolyte.
